(19) United States
(12) Patent Application Publication
(10) Pub. No.: US 2002/0156662 A1
(43) Pub. Date: Oct. 24, 2002

(54) Presentation system for presenting performance and economic data related to steam plant upgrades

(76) Inventors: Troy Christensen, Kennesaw, GA (US); David Moyeda, Laguna Hills, CA (US); Lan Lin, Alpharetta, GA (US); Mark J. Scoretz, Kennesaw, GA (US)

Correspondence Address: PERKINS COIE LLP, PATENT-SEA, P.O. BOX 1247, SEATTLE, WA, 98111-1247, US

(21) Appl. No.: 09/839,601

(22) Filed: Apr. 19, 2001

(51) Int. Cl. G06F 17/60; G05D 3/12; G05D 5/00; G05D 9/00; G05D 11/00; G05D 17/00

(52) U.S. Cl. 705/7

(57) ABSTRACT

A data presentation system for presenting performance and economic data related to upgrading steam turbines and boilers. The data presentation system comprises one or more client computers connected via a computer network to a system server computer that, in turn, is connected to a database. In one embodiment, a steam plant operator or other user logs-in to a steam plant equipment manufacturer's web site and enters information about a steam turbine or boiler that the plant operator wishes to upgrade. In one embodiment, the plant operator also ranks upgrade criteria according to their relative importance to the plant operator. The data presentation system then selects upgrade packages for the steam plant equipment based on the equipment information provided by the user and the user's upgrade criteria ranking. By selecting an icon corresponding to one of the suggested upgrade packages, the user can view graphical data illustrating and comparing the performance and economic benefits associated with the selected upgrade package.

### TECHNICAL FIELD

The described technology relates generally to the presentation of data, and more particularly, to the presentation of performance and economic data related to steam plant upgrades.

### BACKGROUND

Steam plants for generating electricity typically include a steam turbine, a boiler for generating steam to drive the turbine, and a generator coupled to the steam turbine for generating the electricity. There are many reasons a steam plant operator may want to optimize its steam plant by upgrading its boiler or steam turbine systems. Common reasons include increasing the power output and reducing boiler NOₓ emissions. Other reasons may include reducing capital costs, increasing profitability, or increasing equipment reliability.

Typically, when a steam plant operator is considering upgrading a steam turbine or boiler, the plant operator will consult the equipment manufacturer and specify the performance or economic results that the plant operator hopes to achieve by making the upgrade. Based on the plant operator's specifications, the equipment manufacturer's engineers analyze the steam plant and, over a period of time, develop a suggested upgrade package that will presumably provide the desired results. This upgrade package, and the corresponding performance and economic parameters, are then presented to the plant operator so that the plant operator can determine whether or not to undertake the suggested upgrade.

Often, between the time that the plant operator requests information regarding an equipment upgrade and when the manufacturer's response is received, the plant operator's original specifications for the upgrade may have changed, or other design considerations affecting the upgrade package may have arisen that should be considered by the equipment manufacturer. As a result, the steam plant operator is forced to wait while the manufacturer's engineers revisit their upgrade analyses in light of the changed specifications or new considerations. This iterative process for developing a steam plant upgrade package often takes a significant investment of time and energy on behalf of both the steam plant operator and the equipment manufacturer. In addition, this process does not allow the steam plant operator to easily modify its upgrade specifications to quickly compare the cost of one particular upgrade over another.

In light of the time and energy expended to obtain steam plant upgrade data using conventional methods, it would be desirable to have a system in which a steam plant operator could quickly and easily obtain such data. In addition, it would be desirable to have a system in which the steam plant operator could selectively change different upgrade parameters in order to compare the effect of these changes on the cost and performance of the steam plant. Finally, it would also be desirable to have a system that did not require the steam plant manufacturer to expend significant engineering resources every time upgrade information was requested by a steam plant operator.

Since an embodiment of the described technology is implemented using the World Wide Web (“WWW”), an overview of the WWW is provided. The Internet comprises a vast number of computers and computer networks that are interconnected through communication links. The interconnected computers exchange information using various services, such as electronic mail, Gopher, file transfer protocol (“FTP”), and the WWW. The WWW service allows a server computer system (i.e., web server or web site) to send graphical web pages of information to a remote client computer system. (In some instances, the server and client functionality can be hosted on a single computer.) The remote client computer system can then display the web pages.

Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting and the displaying of web pages.

Currently, web pages are typically defined using HyperText Markup Language (“HTML”). HTML provides a standard set of tags that define how a web page is to be displayed. When a user indicates to the browser to display a web page (e.g., by selecting an icon representing that web page), the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems. The content of a web page (e.g., graphic images) may be stored in a resource (e.g., file) that is separate from the web page. In particular, a web page may contain a URL that defines the resource that contains the content. When the web page is displayed, that URL is used to retrieve and then display the content.

### BRIEF DESCRIPTION OF THE DRAWINGS

The file of this patent contains at least one drawing executed in color. Copies of this patent with color drawings(s) will be provided by the Patent and Trademark Office upon request and payment of the necessary fee.

FIG. 1 is a block diagram illustrating components of a data presentation system in one embodiment.

FIG. 2 is a flow diagram of a routine of the data presentation system for presenting steam plant upgrade data.

FIG. 3 is a diagram illustrating a web page for collecting steam plant equipment information.

FIG. 4 is a diagram illustrating a web page for viewing and verifying steam turbine information.

FIG. 5 is a diagram illustrating a web page for entering economic and other steam turbine information.

FIG. 6 is a diagram illustrating a web page for displaying suggested steam turbine upgrades.

FIG. 7 is a flow diagram of a routine of the data presentation system for selecting steam plant equipment upgrade packages.

FIG. 8 is a diagram illustrating a logic table for matching steam turbine upgrade packages to upgrade criteria.

FIG. 9 is a diagram illustrating an availability table listing steam turbine upgrade packages that are technically possible with various steam turbines.

FIG. 10 is a diagram illustrating a web page for displaying performance and economic data associated with a particular steam turbine upgrade package.

FIG. 11 is a diagram illustrating a web page for viewing and verifying boiler information.

FIG. 12 is a diagram illustrating a web page for entering economic and other boiler information.

FIG. 13 is a diagram illustrating a web page for displaying performance and economic data associated with boiler upgrade packages.

FIG. 14 is a diagram illustrating a web page displaying a quote bin in one embodiment.

### DETAILED DESCRIPTION

A data presentation system for presenting steam plant upgrade data using a computer network is provided. In one embodiment, the data presentation system allows a steam plant operator or other user to quickly obtain steam plant upgrade data from a web site, eliminating the need for a time-consuming person-to-person meeting with the steam plant equipment manufacturer. The upgrade data provided by the presentation system includes a comparison of the steam plant's performance before a suggested upgrade to the steam plant's performance after the suggested upgrade. The data presentation system provides the desired upgrade data to the user after the user has entered some basic parameters regarding the upgrade on a display page. The user can compare different upgrade scenarios by changing some of the basic parameters initially entered on this display page. The data presentation system enables the equipment manufacturer to not only respond quickly to user requests for information, but also to conserve its engineering resources that would otherwise be expended generating the upgrade data sought by the user.

In one embodiment, a steam plant operator, wishing to upgrade a steam turbine or boiler, uses a remote client computer to log on to a steam plant equipment manufacturer's web site on a server computer system. In response to the log on, the server computer sends a display page to the remote client computer that enables the plant operator to identify a particular steam turbine or boiler within the operator's fleet. By selecting an appropriate icon, the plant operator elects to upgrade either the steam turbine or boiler and sends this information back to the server computer. If the plant operator elects to upgrade a steam turbine, the server computer sends a display page to the client computer showing the current technical information the server computer has stored in its database about the particular steam turbine the plant operator has elected to upgrade. The plant operator views this information to verify its accuracy, updates it as required, and sends it back to the server computer.

After receiving the updated and verified technical information about the steam turbine from the client computer, the server computer sends a display page to the client computer asking the plant operator to enter some pertinent performance and economic information about the steam turbine to be upgraded. The plant operator will also be asked to rank several different turbine upgrade criteria according to their relative importance to the plant operator. In one embodiment, these criteria are minimizing cost, installation time, maximizing power, and maximizing efficiency. In other embodiments other criteria can be used, such as minimizing emissions, maximizing equipment life, maximizing return on investment, and compatibility with existing systems. Based on which of the upgrade criteria are most important to the plant operator, and based on the pertinent performance and economic information the plant operator submits, the server computer develops a list of suggested turbine upgrade packages that the plant operator can select from to meet its needs.

In one embodiment, the server computer can develop the list of suggested turbine upgrade packages using a logic table that identifies which upgrades best match the plant operator's needs. This logic table is used in conjunction with an availability table that identifies which of the various turbine upgrades are technically possible with the particular steam turbine being upgraded. A turbine upgrade package that is both a best match and is technically possible is identified as a “best match” turbine upgrade package.

After the server computer has developed the list of suggested turbine upgrade packages, the server computer sends a display page to the client computer presenting the list for the plant operator to consider, with the best match turbine upgrade package being identified to the plant operator by appropriate annotation. By selecting one of the turbine upgrade packages listed on the display, the plant operator can view upgrade characteristics that show the effect that particular upgrade package would have on the steam plant's performance and economic returns. In one embodiment, these upgrade characteristics include graphic performance and economic data. This graphic data can include performance charts that compare turbine output before and after the upgrade. In addition, the economic data can include the rate of return on investment that the plant operator should realize on its investment in the turbine upgrade package.

The plant operator can change the parameters used to generate the upgrade characteristics corresponding to the particular turbine upgrade package by changing the values in appropriate data fields on the display. When an appropriate icon is selected, the server computer will retrieve new performance and economic data for the turbine upgrade package using the changed parameters, thus permitting the plant operator to see the effect various parameter changes would have on the performance and economic characteristics of the upgraded steam turbine.

In another embodiment, the steam plant operator can elect to upgrade a boiler. The technique for doing so is substantially similar to the steam turbine upgrade discussed above. The steam plant operator identifies the boiler being used and identifies a boiler performance characteristic—for example, the reduction of NOₓ emissions—that the steam plant operator would like to improve. Based on pertinent performance and economic information about the boiler submitted by the plant operator, the server computer develops a list of suggested boiler upgrade packages that the plant operator can select from to meet its needs. The server computer then sends a display page to the client computer presenting the list for the plant operator to consider. By selecting one of the boiler upgrade packages listed on the display, the plant operator can view upgrade characteristics, such as graphic turbine performance and economic data that shows the effect that particular boiler upgrade package would have on the steam plant's performance and economic returns.

By graphically illustrating to the plant operator the performance and economic benefits of upgrade packages tailored to meet the plant operator's specific needs, and by allowing the plant operator to quickly and easily compare and contrast various turbine and boiler upgrade options, the data presentation system described herein provides a cost effective, instantaneous, and efficient method for a steam plant equipment manufacturer to respond to customer requests for upgrade information and to market its products and services. In addition, by using graphical displays of performance and economic data that are automatically generated by known methods or alternatively precalculated and stored in databases, the steam plant manufacturer will not have to expend engineering resources or perform unique analyses every time a customer requests upgrade information.

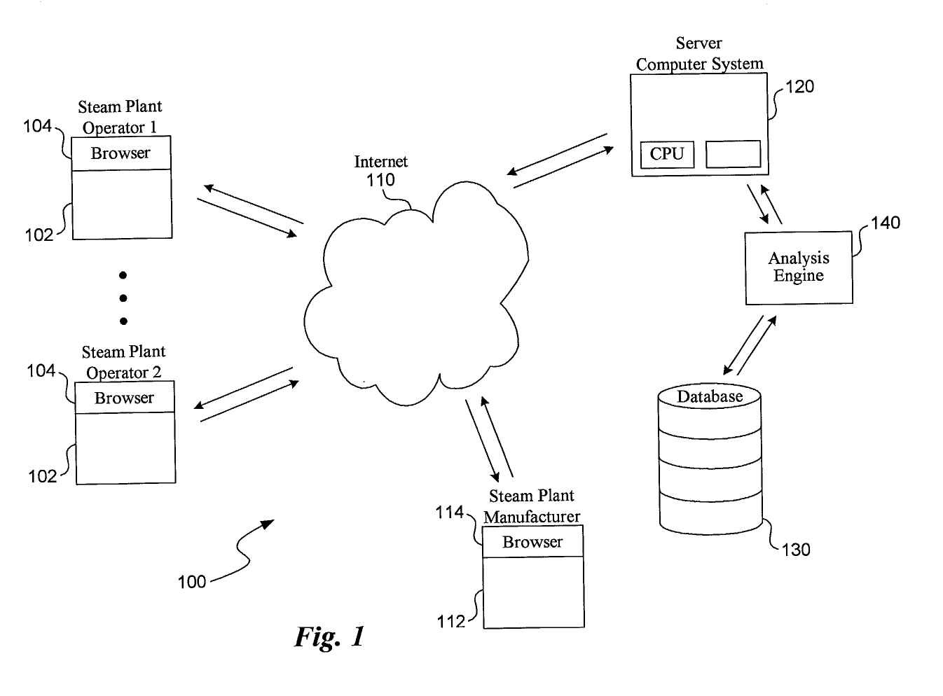

FIG. 1 is a block diagram illustrating components of a suitable computer network 100 in which the data presentation system can be implemented. Although not required, embodiments will be described in the general context of computer-executable instructions, such as routines executed by a general-purpose computer such as a personal computer. Those skilled in the relevant art will appreciate that embodiments of the data presentation system can be practiced with other computer system configurations, including Internet appliances, multiprocessor systems, network PCs, minicomputers, mainframe computers, and the like. For example, embodiments can be practiced with a special purpose computer or data processor that is specifically programmed, configured or constructed to perform as described below. Embodiments can also be practiced in distributed computing environments where tasks or modules are performed by remote processing devices which are linked through a wired or wireless communications network. In a distributed computing environment, program modules or subroutines may be located in both local and remote memory storage devices.

Referring to FIG. 1, a computer network 100 includes one or more client computers 102, each of which includes a browser program module 104. A user of the client computers 102 may be a steam plant operator wishing to upgrade a boiler or steam turbine or otherwise optimize a steam plant. The browser program module 104 permits the user to access and exchange data with an Internet 110, including web sites within the World Wide Web portion of the Internet. The client computers 102 may include one or more central processing units or other logic processing circuitry, memory, input devices (e.g., keyboards and pointing devices), output devices (e.g., display devices and printers), and storage devices (e.g., fixed, floppy, and optical disk drives).

The computer network 100 also includes one or more administrator computers 112. An administrator of the data presentation system may be a steam plant manufacturer who markets steam plant upgrade packages and services to steam plant operators. Each administrator computer 112 is similar to the client computers 102, and includes a browser 114 to permit the administrator to access and exchange information with the Internet 110.

A system server computer 120 connected to the Internet 110 performs many or all of processes of the data presentation system. The server computer 120 contains one or more central processing units (CPU) for executing programs, and a computer-readable medium drive, such as a CD-ROM drive, for reading information or installing programs such as the facility from computer-readable media, such as a floppy disk, a CD-ROM, or a DVD. The server computer system 120 will contain and execute computer-readable media containing instructions for carrying out various steps of the data presentation system. Users and administrators can access the server computer 120 by means of a URL, such as http://www.optimizer.com. The URL, or any link or address noted herein, can be any resource locator. The server computer 120 and related web pages preferably have secure portions that may only be accessed by authorized people, such as authorized users or administrators.

An analysis engine 140 can be used to generate performance and economic data related to steam plant upgrades. After the server computer 120 has selected an upgrade in response to a request from the client computer 102, the analysis engine 140 can provide the server computer 120 with performance and economic data corresponding to the selected steam plant upgrade. The server computer 120 can then provide this data to the client computer 102. A database 130 can be used to store data for the analysis engine 140, and to store data exchanged between the client computers 102 and the server computer 120. The database 130 can also store data exchanged between the administrator computers 112 and the server computer 120. The database 130 also stores technical, geographical, financial, and other information about existing steam plants.

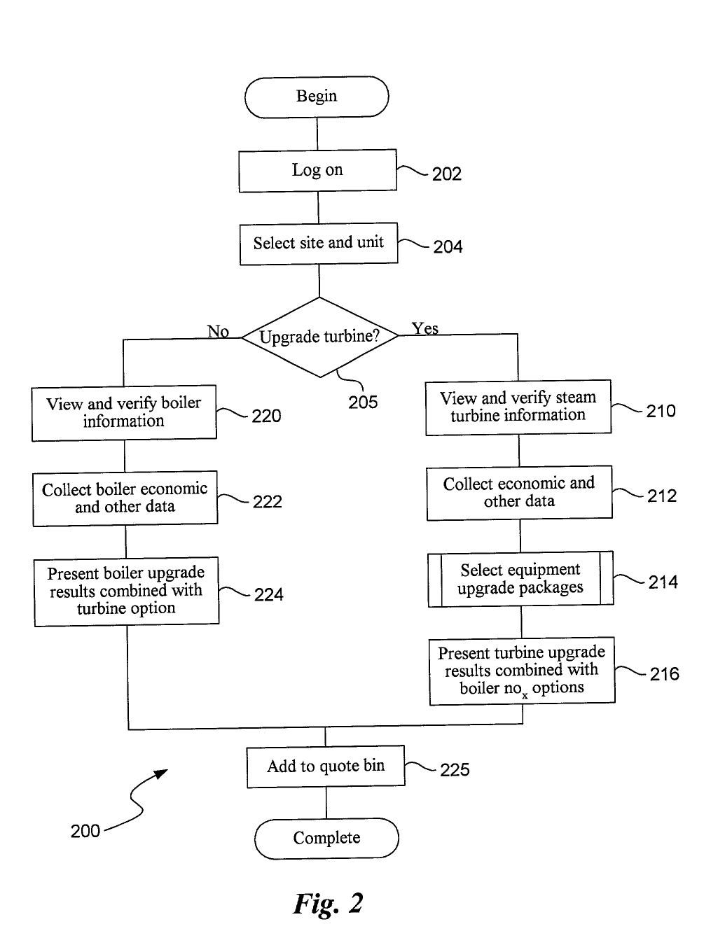

FIG. 2 is a flow diagram of a routine 200 of the data presentation system for presenting steam plant upgrade data to a user. In block 202, the routine receives a log on request from a user using one of the client computers 102. In block 204, the routine receives some basic information entered by the user regarding the steam plant equipment to be upgraded. In decision block 205, if the user has opted to upgrade a turbine, then in block 210 the routine provides information about the turbine to the client computer 102 for the user to view, verify, change (if required), and return. In block 212, the routine receives additional economic and other data from the user regarding the turbine upgrade. In block 214, using the information provided by the user, the server computer 120 selects one or more equipment upgrade packages. In block 216, the server computer 120 presents a turbine upgrade characteristics web page to the client computer 102 so that the user can view performance and economic data related to one or more of the upgrade packages.

If the user elects to upgrade a boiler instead of a steam turbine in decision block 205, then in block 220 the routine sends a web page to the client computer 102 that allows the user to view, verify, and change (if required) information regarding the boiler. In block 222, the routine receives additional economic and other data from the user regarding the boiler upgrade. In block 224, the server computer 120 presents a boiler upgrade characteristics web page to the client computer 102 so that the user can view performance and economic data related to one or more of the upgrade packages. In block 225, the user can obtain a quote for one or more of the upgrades by adding the upgrade to a quote bin.

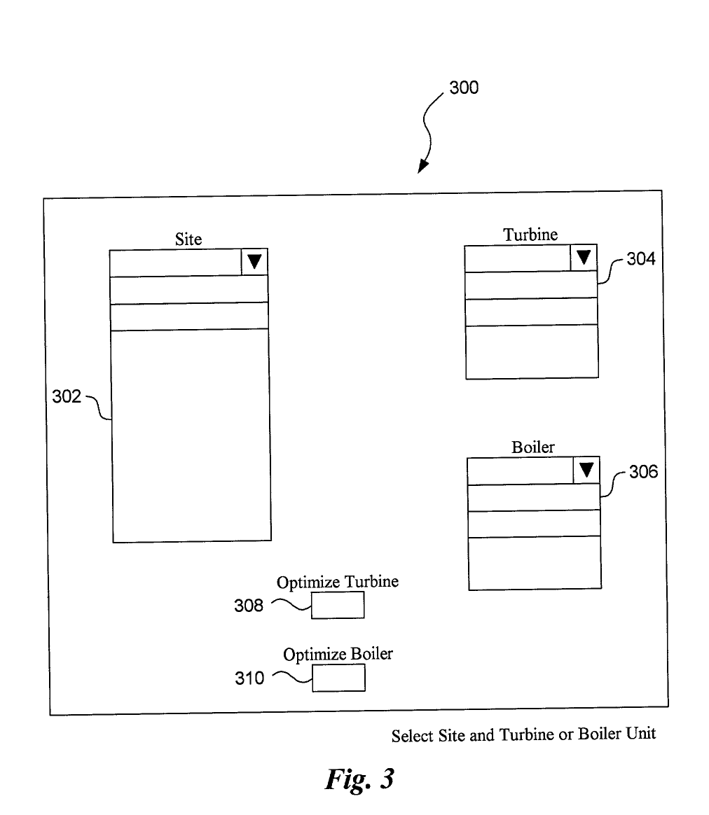

FIG. 3 is a diagram illustrating a web page 300 for collecting information regarding steam plant equipment in accordance with the routine 200. The web page 300 allows a user to select a steam plant site and turbine and boiler model numbers that correspond to the steam plant equipment the user desires to upgrade. The web page 300 contains a site field 302 having a site drop-down list. In one embodiment, the site drop-down list can include a list of sites that contain steam plant equipment manufactured by the steam plant manufacturer and under the control of the steam plant operator. The user can accordingly select the site corresponding to the user's steam plant. The web page 300 also includes a steam turbine field 304 and a boiler field 306. The steam turbine field 304 includes a turbine drop-down list that in one embodiment lists the various types of steam turbines produced by the manufacturer. Similarly, the boiler field 306 includes a boiler drop-down list listing the various types of boilers produced by the manufacturer. Accordingly, the user can select the steam turbine and boiler model numbers on the respective drop-down lists that correspond to the turbine and boiler models the user intends to upgrade. If the user desires to upgrade the steam turbine, the user will accordingly select an optimize turbine icon 308. If, instead, the user desires to upgrade the boiler, the user will select an optimize boiler icon 310.

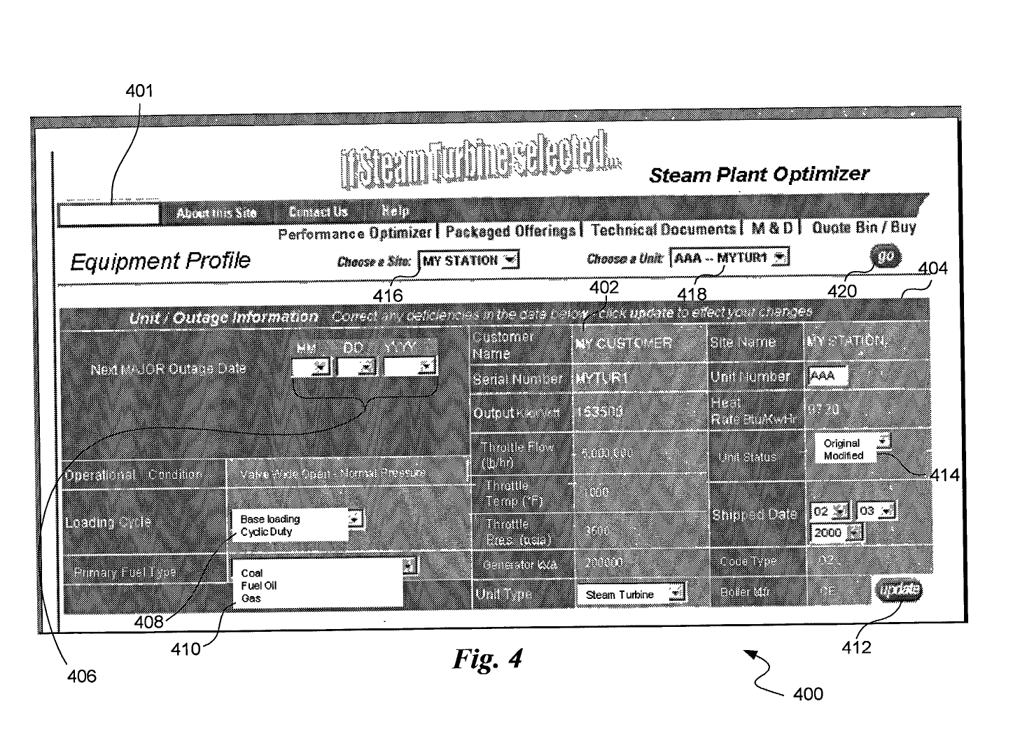

FIG. 4 is a diagram illustrating a web page 400 for viewing and verifying information about the selected steam turbine in accordance with the routine 200. The web page 400 gives the user an opportunity to verify unit-specific technical information and make changes where appropriate. This information will be used by the server computer 120 to provide the turbine performance and economic displays which follow. Icons 401 displayed across the top of the web page 400 allow the user to obtain information about the equipment manufacturer and other services provided by the data presentation system. Specific known data concerning the selected steam turbine, such as output in kilowatts, throttle flow, throttle temperature, throttle pressure, and generator output, is included in a technical data portion 402. In addition to this data, unit specific data such as the unit number, heat rate, modification status, and shipping date is included in a unit data portion 404. If a unit modification field 414 indicates the steam turbine has been modified, then the steam plant manufacturer may have to perform additional analyses before using the data presentation system. In a major outage date field 406, the user can input an upcoming outage date when upgrades to the steam turbine could potentially be carried out without impacting normal turbine operations. In a loading cycle field 408, the user selects either base loading or cyclic duty depending on the type of steam turbine being upgraded. Base loading refers to a turbine that can operate at full load (close to 100% capacity) year round except for normal maintenance (normal outage). Cyclic loading refers to a turbine that may start or stop every day or every week, depending on the use requirement. In a fuel type field 410, the type of boiler fuel, such as coal, fuel oil, or gas, is selected by the user.

If any of the existing information in the various fields of the web page 400 is incorrect, the user can type the correct information in the field and select an update icon 412 to save the correct information on the server computer 120 or database 130. The user can select a different site by choosing the site on a choose a site drop-down list 416, or select a different turbine for upgrading by choosing the turbine on a choose a unit drop-down list 418. Once the user is satisfied that the information contained on the web page 400 is correct, the user can select a go icon 420 to proceed with the routine 200 of FIG. 2.

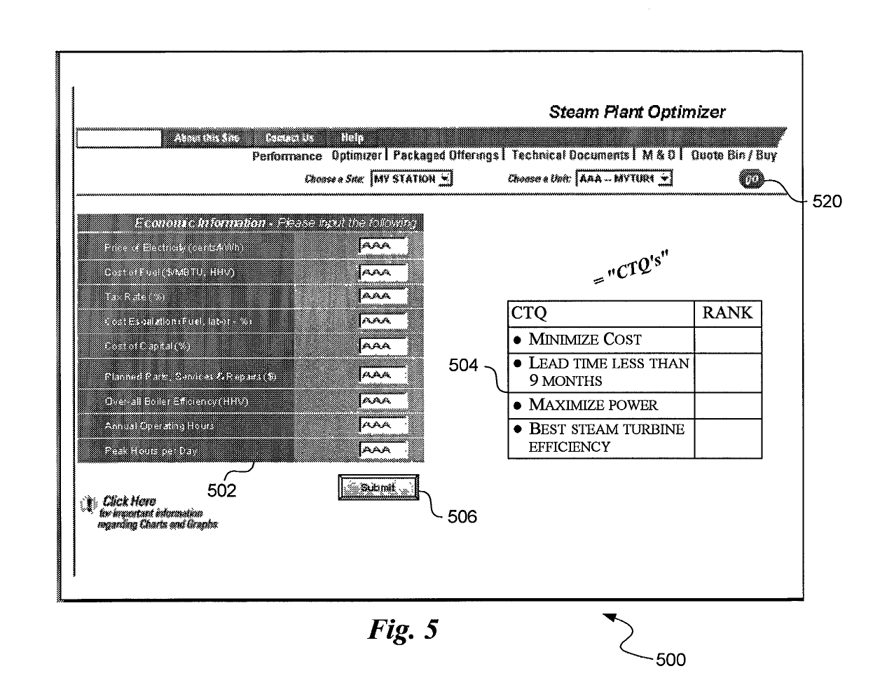

FIG. 5 is a diagram illustrating a web page 500 that can be displayed on the client computer 102 for collecting economic and other turbine data from the user, in accordance with the routine 200. Specific information regarding a number of economic factors can be entered into appropriate fields in an economic information portion 502. In one embodiment, this information includes the price of electricity the user will sell; the cost of boiler fuel; the applicable tax rate; the cost escalation of overhead; the cost of capital; the cost of planned parts, services and repairs; the overall boiler efficiency; the number of annual operating hours; and the peak operating hours per day. This economic information will be used by the server computer 120 to calculate, using known analytical methods, and the economic results of the suggested turbine upgrades.

Because the user elected to upgrade a steam turbine, a critical to quality (“CTQ”) portion 504 will also be displayed on the web page 500. The CTQ portion 504 presents four turbine upgrade criteria which the user should rank in terms of relative importance. In one embodiment, the criteria are minimize cost, installation (“lead”) time less than nine months, maximize power, and best turbine efficiency. The CTQ ranking provided by the user is used by the server computer 120 to develop a list of suggested turbine upgrades that will best suit the user's needs. Other CTQ criteria can be used. For example, criteria such as maximize component life, maximize return on investment, maximize compatibility with existing systems, or minimizing emissions can be used in accordance with an embodiment. After the user has entered the economic information in the economic information portion 502 and ranked the CTQ criterion in the CTQ portion 504, the user selects a submit icon 506. The server computer 120 will take this economic information and CTQ ranking, in addition to the steam turbine information, and select steam turbine upgrade packages for presentation to the user.

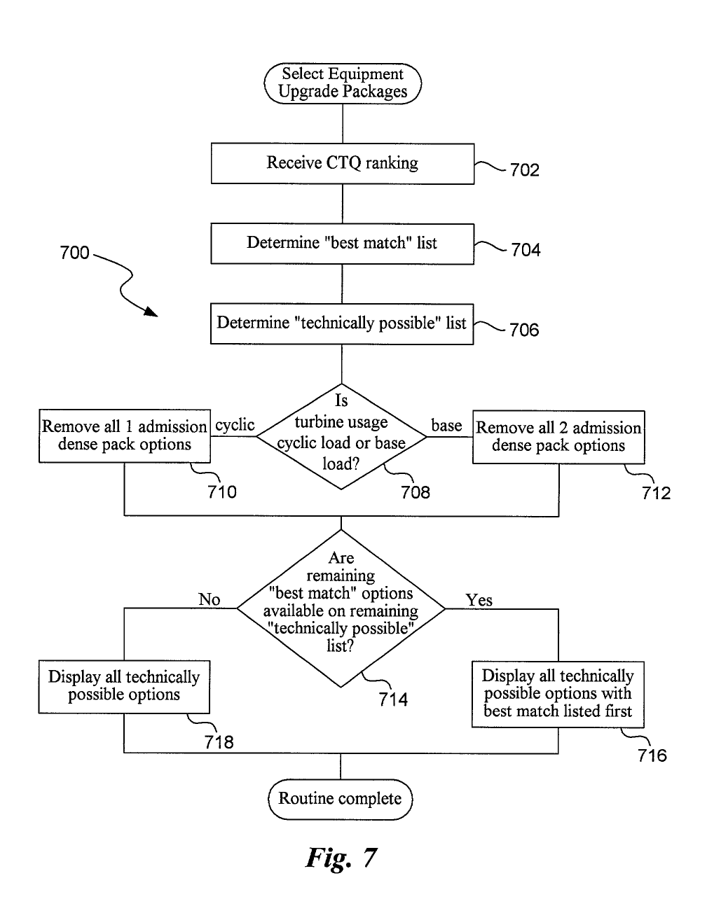

FIG. 7 is a flow diagram of a routine 700 for selecting equipment upgrade packages for presentation to a user in accordance with the routine 200. In block 702, as already discussed, the routine receives a user ranking of the CTQ criteria listed in the CTQ portion 504 of the web page 500. In block 704, the routine 700 determines which of the manufacturer's turbine upgrade packages offer a “best match” with the user's CTQ ranking. In block 704, the routine 700 determines which of the manufacturer's turbine upgrade packages are “technically possible” with the user's steam plant equipment. In decision block 708, if the user's turbine usage is cyclic load, then in block 710 all 1-admission dense pack options are removed from both the best match list and the technically possible list; if the user's turbine usage is base load, then in block 712 all 2-admission dense pack options are removed from these lists. In decision block 714, if any remaining best match options are on the remaining technically possible list, then in block 716 all remaining technically possible options are presented with the remaining best match options listed first and noted; if no remaining best match options are on the technically possible list, then in block 718 all remaining technically possible options are displayed without any of the best match options.

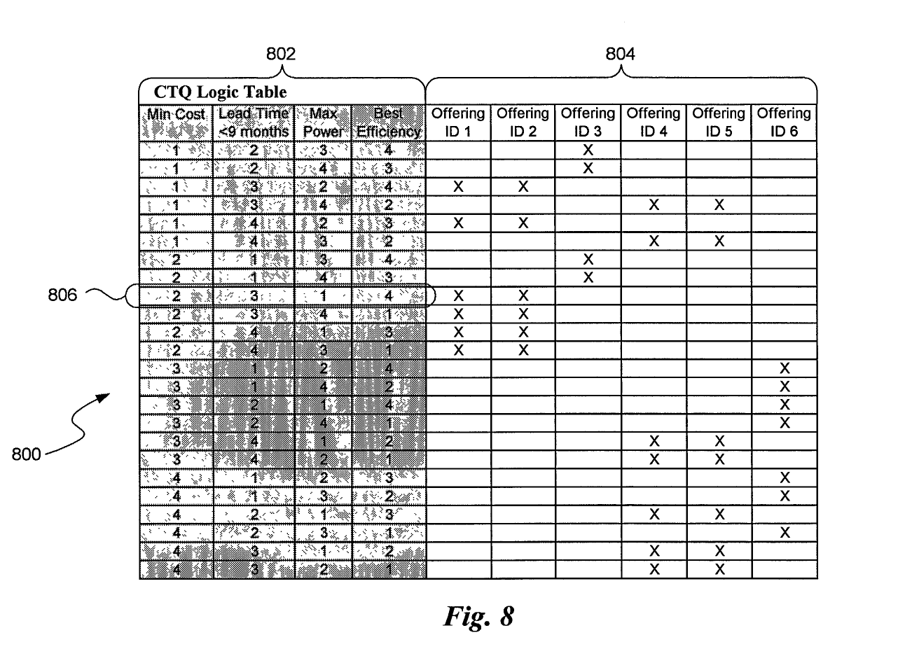

FIG. 8 is a diagram illustrating a CTQ logic table 800 that can be used to determine which of the manufacturer's turbine upgrade packages offer a “best match” with the user's CTQ ranking, in accordance with the routine 700. The CTQ logic table 800 has a CTQ portion 802 having a column corresponding to each of the four CTQ criterion enumerated in the CTQ portion 504 of the web page 500. The 24 rows of the CTQ portion 802 include all the possible combinations of CTQ rankings. An upgrade field 804 is displayed adjacent to the CTQ portion 802 and includes six columns, each corresponding to a different turbine upgrade package. An “x” in an upgrade column indicates that that upgrade is a “best match” to satisfy the corresponding adjacent CTQ ranking. Whether a particular turbine upgrade package is a best match or not can be determined by using analytical methods known in the steam turbine arts, or alternatively known empirical methods, to assess how well, in comparison to other options, the particular package satisfies the user's CTQ ranking. As shown, two upgrade packages can be “best matches.” For example, if the user has selected a CTQ ranking 806, then both ID 1 and ID 2 are best match upgrade options, and together they comprise a “best match list” of turbine upgrade packages for that CTQ ranking.

In the illustrated embodiment, an upgrade ID 1 corresponds to a Dense Pack 1-admission, an ID 2 corresponds to a Dense Pack 2-admission, an ID 3 corresponds to an Advanced Design Steam Path (“ADSP”), an ID 4 corresponds to a Dense Pack 1-admission with a new 26″ last stage bucket, an ID 5 corresponds to a Dense Pack 2-admission with a new 26″ last stage bucket, and finally an ID 6 corresponds to an ADSP with a new 26″ last stage bucket. As is known to those of skill in the art, in a 1-admission, or “single admission” steam turbine, all the control valves that introduce steam into the turbine connect into a common bowl area ahead of the first stage nozzles. To control steam flow, all valves move together in a “single admission.” In a partial admission turbine, the first stage nozzle is divided into separate nozzle arcs, and each arc is supplied with steam through a separate control valve. These valves can move together or in sequence, to result in two or more “admissions.” The term “dense pack” refers to increasing the number of turbine stages in an existing turbine space.

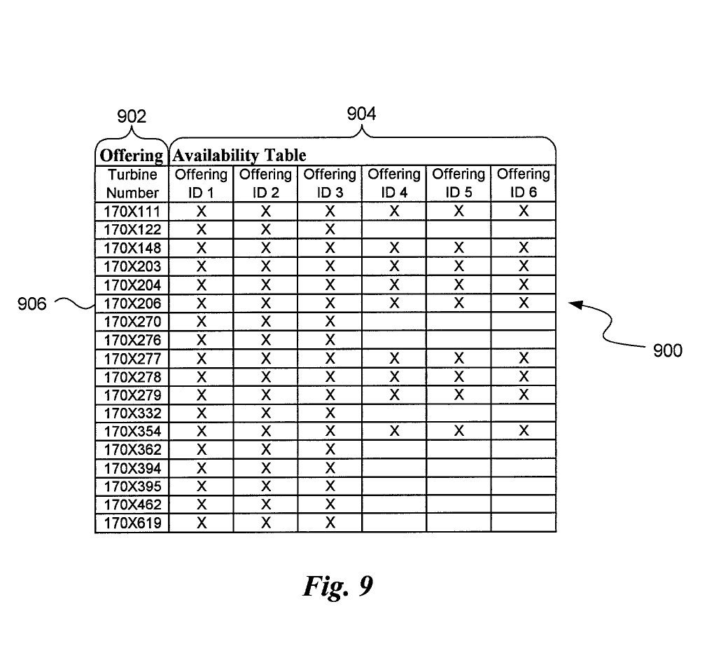

FIG. 9 is a diagram illustrating an availability table 900 for determining which turbine upgrade packages are technically possible, in accordance with the routine 700. The availability table 900 includes a turbine model number column 902 listing turbine model numbers and an adjacent upgrade availability portion 904. The upgrade availability portion 904 includes six columns, each corresponding to one of the six different turbine upgrade packages also shown in the CTQ logic table 800 of FIG. 8. For each turbine model number in the column 908, an “x” marked in a corresponding turbine upgrade column indicates that that upgrade package is technically possible for that particular turbine model. For example, if the user has specified a turbine model number 906, then turbine upgrade packages ID1-ID6 are all technically possible, and together they comprise a “technically possible list” of turbine upgrade packages for that model number.

After determining the technically possible list of turbine upgrades, the server system determines if the turbine loading cycle is cyclic load or base load. The type of loading cycle should have been specified by the user in the loading cycle field 408 of the web page 400 of FIG. 4. If the turbine usage is based on a cyclic loading cycle, the server removes all Dense Pack 1-admission upgrade options from both the best match list and the technically possible list of turbine upgrade packages, because these upgrade options are not compatible with a cyclic loading cycle. Conversely, if the turbine usage is based on a base loading cycle, then the server removes all Dense Pack 2-admission upgrade options from both the best match list and the technically possible list of turbine upgrade packages, because these options are not compatible with a base loading cycle. As should be apparent from the availability table 900, after all of either the Dense Pack 1-admission or 2 admission options have been removed from the technically possible list in accordance with blocks 710 or 712 (the 1-admission options being ID1 and 4; the 2-admission options being ID2 and ID5), then at most only four turbine upgrade options will remain on the technically possible list for any turbine model number. After carrying out the same exercise on the best match list in the CTQ logic table 800, it should also be apparent that only one best match turbine upgrade option will remain on the best match list for any CTQ ranking. In an alternate embodiment, no turbine upgrade package options need to be removed from the best match list or the technically possible list if all the options are compatible with either type of turbine loading cycle.

In decision block 714, the routine 700 determines if the remaining best match upgrade option is also listed on the remaining technically possible upgrade list. If so, then in block 716 the routine 700 will display to the user all of the technically possible upgrade options remaining, with the best match option being listed first and highlighted. Conversely, if the remaining best match option is not available on the technically possible list, then in block 718 the routine 700 will display to the user all of the technically possible upgrade options remaining on the technically possible upgrade list, without any being highlighted as a best match.

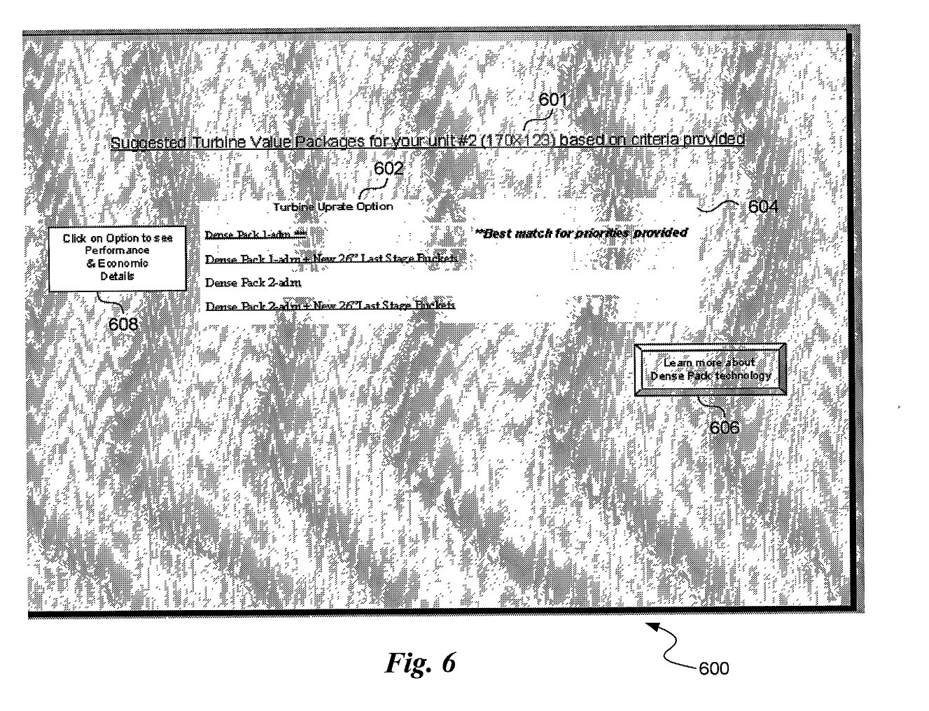

FIG. 6 is a diagram illustrating a web page 600 that can be displayed on the client computer 102 for presenting a list of suggested turbine upgrade packages to a user, in accordance with the routine 700. A title bar 601 displays the steam turbine model number so that the user can verify at a glance that the data on the web page 600 corresponds to the correct turbine. A turbine upgrade portion 602 displays suggested turbine upgrade packages in descending order. In the illustrated embodiment, the turbine upgrade portion 602 includes a Dense Pack 1-admission option, a Dense Pack 1-admission option plus a 26″ last stage bucket, a Dense Pack 2-admission option, and a Dense Pack 2-admission option with a new 26″ last stage bucket. A learn more icon 606 can be selected by the user to learn more about the Dense Pack turbine technology of the manufacturer incorporated into the various turbine upgrade packages. As shown in a comment portion 604 adjacent to the turbine portion 602, the Dense Pack 1-admission option, as indicated by the double asterisks, is the upgrade package that best matches the CTQ criteria ranking provided by the user on the web page 500 of FIG. 5. An information box 608 explains to the user that by selecting one of the suggested turbine upgrade packages listed in the upgrade portion 602, the user can view data illustrating how the selected turbine upgrade package will enhance the performance and economic return of the user's steam plant.

At this juncture, the server computer 120 has presented a list of suggested turbine upgrade packages designed to meet the user's needs, as indicated by the user's CTQ criteria ranking. The user can now select any one of the suggested upgrade packages in the upgrade portion 602 of the web page 600 to request performance and economic data associated with the selected upgrade package. After the user does so, in block 216 of the routine 200 of FIG. 2 the server computer 120 provides the requested display of performance and economic data to the client computer 102.

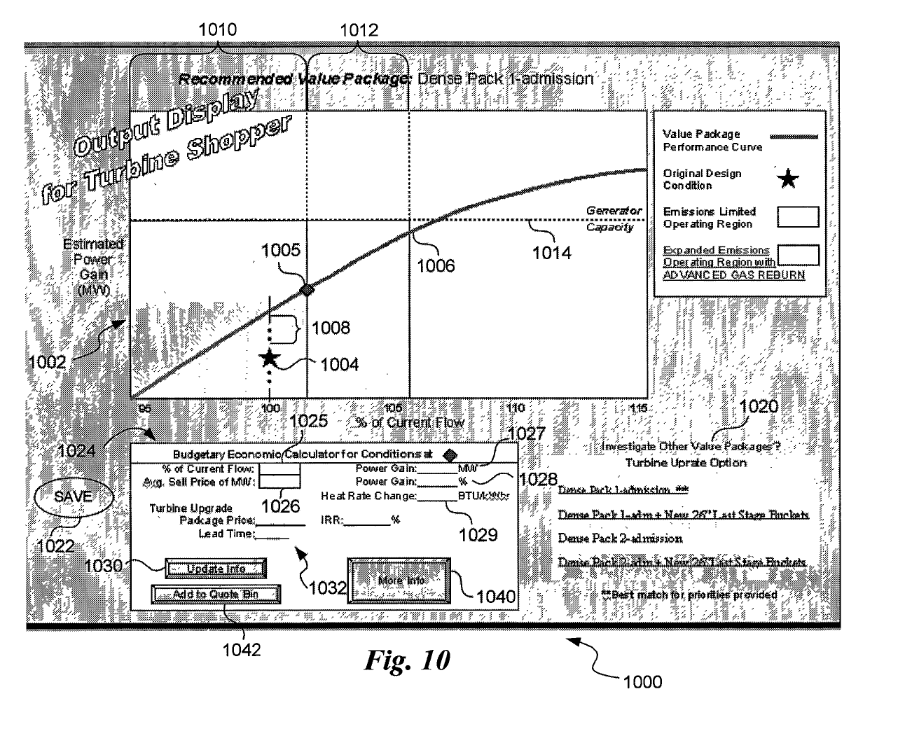

FIG. 10 is a diagram illustrating a web page 1000 that can be displayed on the client computer 102 for presenting steam turbine performance and economic data related to a particular upgrade package, in accordance with the routine 200. The web page 1000 includes a turbine performance chart 1002. The percent of steam flow through the turbine is measured on the horizontal axis of the chart 1002, and the estimated power in megawatts is measured on the vertical axis. The chart 1002 contains a star 1004 which indicates the new and clean condition of the turbine without any of the suggested upgrades. A curve 1006 indicates the potential performance of the turbine if the selected upgrade package is adopted, so that a vertical distance 1008 between the star 1004 and the curve 1006 represents the increase in turbine performance at the current steam flow that could be obtained by making the suggested upgrade.

A green portion 1010 of the chart 1002 indicates the area in which the steam turbine can operate without the boiler exceeding the current prescribed NOₓ emissions levels. In the illustrated example, this means that the steam generated by the boiler can only be increased to approximately 102% of its current flow before the prescribed NOₓ emissions levels are exceeded. Thus, a diamond 1005 on the curve 1006 indicates the maximum performance of the steam turbine after the suggested upgrade has been made, unless further upgrades are carried out on the boiler to reduce NOₓ emissions. A yellow portion 1012 of the chart 1002 represents the area in which the turbine can operate if a suggested upgrade is made to the boiler to reduce NOₓ emissions. In the illustrated example, this means that the steam flow through the turbine could be increased to approximately 106% of its current value without exceeding the prescribed NOₓ emissions levels after the upgrade. A dotted horizontal line 1014 on the chart 1002 indicates the actual capacity of the generator coupled to the steam turbine, and thus it makes no sense to increase turbine performance beyond that which the generator is capable of handling.

In a what-if box 1024, the user is able to see what effect changing the flow of steam through the turbine, or changing the price of a megawatt of electricity, will have on the performance and economic aspects of the steam turbine. A flow field 1025 shows the steam flow as a percent of the current flow, with 100% being the default position. In a price field 1026, the average selling price of a megawatt of electricity is provided. Both pieces of data in the fields 1025 and 1026 can be changed by the user to see the corresponding effect on power output and the rate of return on investment. To update the data to reflect changed values, the user simply types the new values into the respective fields and selects an update info icon 1030. The turbine power output gain corresponding to the steam flow is shown in megawatt units in a power gain field 1027, and shown as a percentage of the current power output in a second power gain field 1028. Similarly, the heat rate change, in BTU/kilowatt/hours, is shown in a heat rate field 1029. The cost of the turbine upgrade package, the user's expected initial rate of return (“IRR”), and the lead time to install the turbine upgrade package are all displayed for the user in an upgrade information portion 1032 of the what-if box 1024. If at any time the user desires to learn more about the technology associated with the particular turbine upgrade package, the user selects a more info icon 1040.

If at any time the user wishes to view a performance chart and economic data corresponding to one of the other suggested turbine upgrade packages, the user can do so by selecting the desired upgrade package in an option portion 1020. To save any displayed data, the user simply selects a save icon 1022, and the web page 1000 can be saved to a storage medium on the server computer 120 so that the user can refer to it in the future. The save icon 1022 allows the user to enter a name or other identifier under which the data will be saved on a hard drive or other storage device on the client computer 102. As shown in block 225 of the routine 200 in FIG. 2, if the user determines it would like to purchase the turbine upgrade package corresponding to the data displayed on the web page 1000, then the user selects an add to quote bin icon 1042 and the quoted price of the upgrade package will accordingly be added to a total quote subsequently submitted to the user.

In one embodiment, the performance and economic data presented on the web page 1000 is calculated with the analysis engine 140 using known methods for a particular turbine model at a particular steam plant site. When the user selects one of the turbine upgrade packages listed in the upgrade portion 602 of the web page 600, the server computer 120 retrieves the performance charts and economic data corresponding to that particular upgrade package from the analysis engine 140 and transmits this data to the client computer 102 for display. In an alternate embodiment, this data may be precalculated and stored in numerical and graphical format on the database 130. In this alternate embodiment, when the user selects one of the turbine upgrade packages listed in the upgrade portion 602 of the web page 600, the server computer 120 retrieves the performance charts and economic data corresponding to that particular upgrade package from the database 130 and transmits this data to the client computer 102 for display.

Methods for estimating the performance and economic aspects of a steam turbine are known in the relevant art. Any of these known methods can be used to compare and contrast the performance of a steam turbine without any upgrade to the performance of the steam turbine with a particular upgrade, such as was done to create the performance chart 1002 on the web page 1000. Regardless of the particular methods used to estimate and compare turbine performance, the data presentation system of the present embodiment can be used to select which particular performance charts and economic data should be displayed to a particular user based on the turbine information provided by the user and the user's ranking of the CTQ criteria as explained above.

Returning to the routine 200 in FIG. 2, if the user elects to upgrade a boiler in decision block 205 instead of a steam turbine, as indicated by the user selecting the optimize boiler icon 310 on the web page 300 in FIG. 3, then in block 220 the routine will send a web page to the client computer 102 that allows the user to view and verify information regarding the boiler the user has selected.

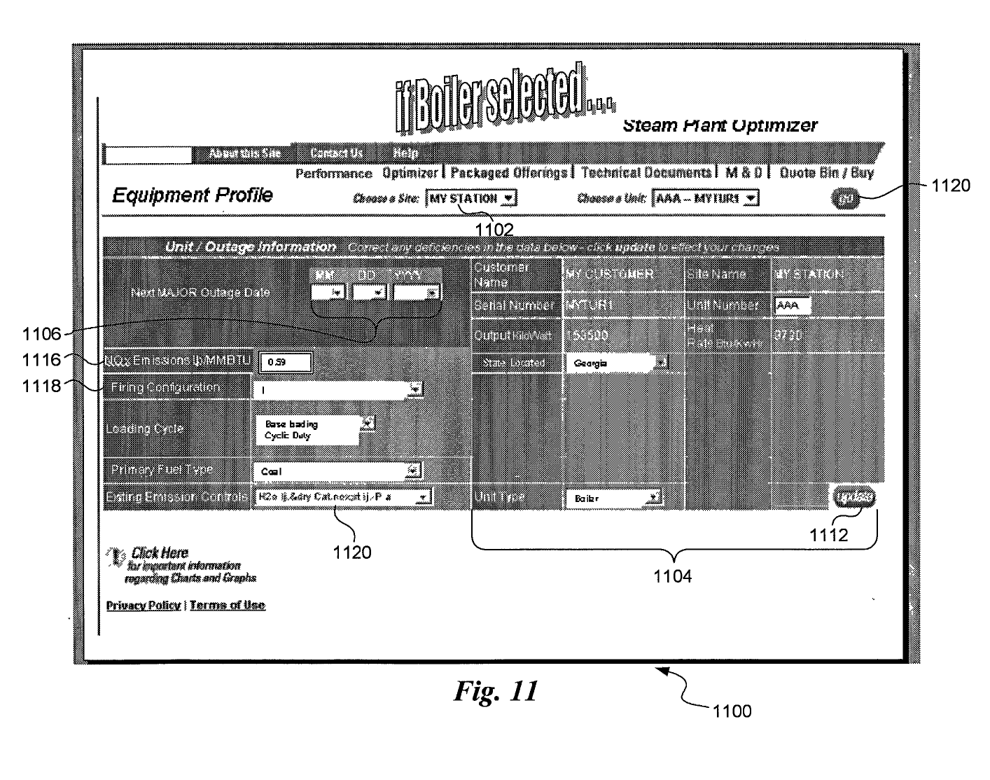

FIG. 11 is a diagram illustrating a web page 1100 that can be displayed on the client computer 102 for viewing and verifying information about the selected boiler, in accordance with the routine 200. The web page 1100 is similar to the web page 400 shown in FIG. 4 for a steam turbine and shares common information. The web page 1100 has a boiler site field 1102 and a boiler information portion 1104. A major outage date field 1106 is included to provide an indication of when the boiler upgrade could be made without impacting normal steam plant operations. The current NOₓ emissions level of the boiler is entered by the user in a NOₓ emissions field 1116. A drop-down list in a firing configuration field 1118 allows the user to select the boiler's firing configuration. An existing emissions control field 1120 having a drop-down list allows the user to specify the specific type of local emissions controls that have already been installed on the boiler.

The information presented to the user on the web page 1100 can be based on boiler information previously stored in the database 130 that was collected by the equipment manufacturer when originally installing the boiler. If the user elects to update any of the information presented, the user can do so by entering the new data accordingly in the appropriate field and selecting an update icon 1112. Once the user is satisfied that the boiler information on the web page 1100 is correct, the user selects a GO icon 1120. Returning to FIG. 2, in block 222 the routine 200 proceeds by collecting economic and other data from the user that will be used by the server computer 102 to determine which boiler upgrade options to offer.

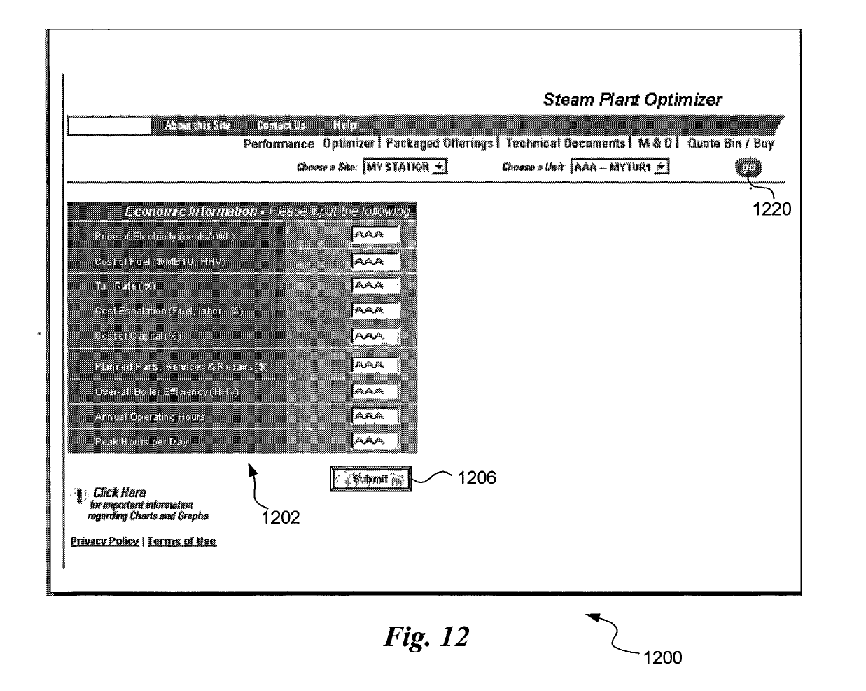

FIG. 12 is a diagram illustrating a web page 1200 that can be displayed on the client computer 102 for collecting economic and other boiler data from the user, in accordance with the routine 200. The web page 1200 as used for a boiler upgrade is substantially similar to the web page 500 of FIG. 5 as used for a turbine upgrade; however, the web page 1200 does not include a CTQ ranking portion. The user enters pertinent boiler information in a boiler information portion 1202. In this embodiment, the pertinent boiler information includes the price of electricity the user will sell; the cost of boiler fuel; the applicable tax rate; the cost escalation; the cost of capital; the cost of parts, services, and repairs; the overall boiler efficiency; the annual operating hours; and the number of peak hours per day that the boiler will be operating. Once the user is satisfied that the information in the boiler information field 1202 is correct, the user can proceed by selecting a submit icon 1206. Returning to the routine 200 of FIG. 2, in block 224 the server computer 120 provides a display of the performance and economic data associated with several boiler upgrade packages to the client computer 102.

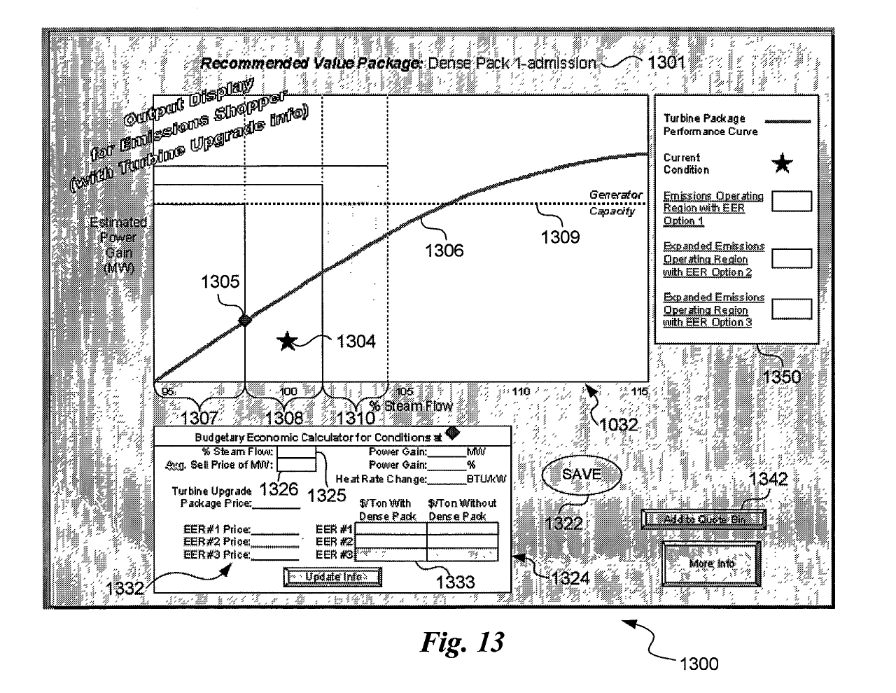

FIG. 13 is a diagram illustrating a web page 1300 that can be displayed on the client computer 102 for presenting steam plant performance and economic data to the user, in accordance with the routine 200. The data presented on the web page 1300 is for a given steam plant having a particular steam turbine and boiler. The data illustrates turbine output performance and boiler NOₓ emissions levels for a particular turbine upgrade package with three alternative boiler upgrade package options. A title 1301 on the web page 1300 indicates to the user which particular steam turbine upgrade package is being used in conjunction with the alternative boiler upgrade options to generate the data shown. A boiler upgrade option portion 1350 lists the three alternative boiler upgrade options as Option 1, Option 2, and Option 3. These boiler upgrade options can involve changing the primary boiler fuel, changing the boiler firing configuration, and incorporating NOₓ emissions control technologies. These upgrades can be directed to improving boiler performance, improving boiler economics, or reducing NOₓ emissions.

The web page 1300 also includes a boiler emissions/turbine performance chart 1302. The steam flow through the turbine is measured on the horizontal axis of the performance chart 1302, and the estimated power gain in megawatts is measured on the vertical axis. A star 1304 on the performance chart 1302 indicates the current steam turbine performance without any of the suggested turbine or boiler upgrades. A curve 1306 on the performance chart 1302 indicates the increased turbine performance available if the suggested turbine upgrade package, as indicated in the title 1301, is implemented by the user.

A green portion 1307 indicates the percentage of current steam flow possible if the user adopts the first boiler upgrade option. Thus, if the user selects the first boiler upgrade option, then approximately 98% of the current steam flow through the turbine would be possible. However, as a diamond 1305 on the performance chart 1302 indicates, if the suggested turbine upgrade package is used, then even at that reduced steam flow the turbine would still produce more power than it does in the current configuration. A yellow portion 1308 of the performance chart 1302 indicates the percentage of the current steam flow possible if the second boiler upgrade option is adopted by the user. Significantly, the vertical distance between the star 1304 and the performance curve 1306 indicates the amount of additional power that can be gained by adopting the suggested turbine upgrade package and the second boiler upgrade option, without increasing the steam flow. A blue portion 1310 indicates the percentage of current steam flow possible if the third boiler upgrade option is adopted. A horizontal dotted line 1309 indicates the current generator capacity, and thus, the steam flow could be increased to approximately to 104% of the current flow using the third boiler upgrade option without exceeding the generator's capacity.

The web page 1300 also includes a what-if box 1324 that is similar to the what-if box 1024 on the web page 1000 in FIG. 10. The what-if box 1324 initially presents economic data related to the boiler operating at the diamond condition 1305. The steam flow through the turbine is shown as a percentage of existing steam flow in a steam flow field 1325, and the selling price of a megawatt of electricity is shown in a price field 1326. The user can elect to change the steam flow or the average selling price of a megawatt of electricity to see the effects such changes will have on the economic data. A boiler upgrade package price field 1332 lists the price associated with each of the three boiler upgrade packages. A cost-per-ton portion 1333 indicates the cost of the three different boiler upgrade packages per ton of steam flow. The numbers are presented with and without the particular turbine upgrade package, so that the user can see how adopting the turbine upgrade package can reduce the cost of adopting one of the boiler upgrade packages. The user can elect to save the boiler upgrade display by giving it a unique name and selecting a save icon 1322. This allows the user to retrieve the displayed data for use at a later time. If the user elects to purchase a particular boiler upgrade option, selecting an add to quote bin icon 1342 will add the quoted price of the upgrade to the quote bin, as shown in block 225 of the routine 200 of FIG. 2.

Methods for generating a steam turbine performance curve that illustrates the effect of various boiler upgrade options, such as that presented on the web page 1300, are known in the relevant art. In addition, boiler emissions data corresponding to a particular boiler upgrade can be assembled in a look-up database table that the server computer 120 refers to based on the input provided by the user. Whichever method is used to generate a steam turbine performance curve that includes boiler emissions data, the data presentation system of the current embodiment can be used to present the data to a user and aid the user in determining whether or not to purchase the particular turbine or boiler upgrade package.

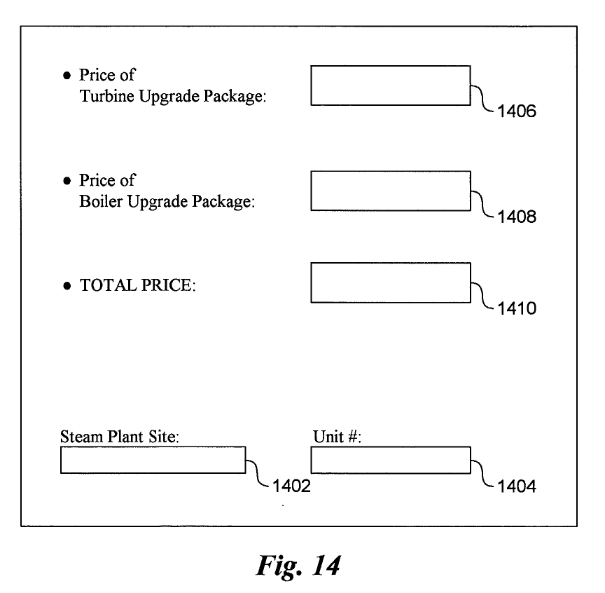

FIG. 14 is a diagram illustrating a web page 1400 of a quote bin display in one embodiment, in accordance with the routine 200. The web page 1400 includes a steam plant site field 1402 and a unit number field 1404, so that the user can be assured that the price quotes correspond to the correct site and unit. A turbine upgrade field 1406 displays the price of the selected turbine upgrade and a boiler upgrade field 1408 similarly displays the price of the selected boiler upgrade. The combined total price is accordingly displayed in the total price field 1410. If the user adds an item to the quote bin from either the turbine web page 1000 or the boiler web page 1300, the server computer 120 will capture all of the associated input data and optimization output data and store it in the database 130 for future use. If the user desires to log back into the data presentation system in the future, the user can retrieve and view the various display screens from the quote bin.

Based on the above description, it will be appreciated that although various embodiments of the technology have been described for purposes of illustration, various modifications may be made to the embodiments without deviating from the spirit and scope of the invention. Accordingly, the invention is not limited except by the appended claims.

We claim:

1. A method in a computer system for presenting data related to upgrading steam plant equipment, the method comprising:
receiving a request related to upgrading the steam plant equipment;
providing an information display description configured to receive selected information about the steam plant equipment;
receiving the selected information about the steam plant equipment;
selecting an upgrade for the steam plant equipment based on the received selected information about the steam plant equipment;
retrieving an upgrade display description from an analysis engine, the upgrade display description containing upgrade characteristics corresponding to the selected upgrade of the steam plant equipment; and
providing the upgrade display description.

2. The method of claim 1 further comprising:
providing an upgrade criteria display description containing a plurality of steam plant equipment upgrade criteria, the upgrade criteria display description being configured to receive a ranking of the upgrade criteria;
receiving the ranking of the upgrade criteria; and
selecting an upgrade for the steam plant equipment based on the received selected information about the steam plant equipment and the received ranking of the upgrade criteria.

3. The method of claim 2 wherein the steam plant equipment has an identification number, and wherein selecting an upgrade for the steam plant equipment comprises:
identifying one or more best match upgrades that correspond to the received ranking of the upgrade criteria from a best match table that maps upgrades to rankings of the upgrade criteria;
identifying one or more technically possible upgrades that correspond to the steam plant equipment's identification number from a technically possible table that maps upgrades to identification numbers; and
selecting an upgrade for the steam plant equipment based on the identified best match upgrades and the identified technically possible upgrades.

4. The method of claim 3 further comprising discarding any best match upgrades that are not also technically possible upgrades.

5. The method of claim 2 wherein providing an upgrade criteria display description comprises providing a display description containing a cost criterion field, an installation time criterion field, a power criterion field, or an efficiency criterion field.

6. The method of claim 1 wherein providing the information display description comprises providing a display description having an equipment identification field and a next major outage date field.

7. The method of claim 1 wherein retrieving an upgrade display description comprises retrieving a display description that illustrates an aspect of the steam plant equipment's performance both with the upgrade and without the upgrade.

8. The method of claim 1 wherein the steam plant equipment comprises a steam turbine and a boiler, the boiler producing NOx emissions, and wherein retrieving an upgrade display description comprises retrieving a display description that illustrates an aspect of the steam turbine's performance and an aspect of the boiler's NOx emissions.

9. The method of claim 1 wherein retrieving an upgrade display description containing upgrade characteristics comprises retrieving an upgrade display description containing a performance chart or economic data corresponding to the selected upgrade of the steam plant equipment.

10. A method in a computer system for selecting one or more upgrades for steam plant equipment, the one or more upgrades being based on selected upgrade criteria, the method comprising:
identifying one or more best match upgrades corresponding to the selected upgrade criteria from a best match mapping that maps upgrades to upgrade criteria;
identifying one or more technically possible upgrades corresponding to the steam plant equipment from a technically possible mapping that maps upgrades to steam plant equipment; and
selecting one or more upgrades for the steam plant equipment based on the identified best match upgrades and the identified technically possible upgrades.

11. The method of claim 10 further comprising discarding any best match upgrade that is not also a technically possible upgrade.

12. The method of claim 10 wherein the steam plant equipment is a steam turbine having a loading cycle, wherein the loading cycle is a base loading or a cyclic duty loading cycle, and wherein the method further comprises discarding one or more of the technically possible upgrades if the loading cycle is the cyclic duty loading cycle.

13. The method of claim 10 wherein the steam plant equipment is a steam turbine having a loading cycle, wherein the loading cycle is a base loading or cyclic duty loading cycle, and wherein the method further comprises discarding one or more of the technically possible upgrades if the loading cycle is the base loading cycle.

14. A method in a server computer system for transmitting turbine upgrade data to a user computer system, the method comprising:
receiving from the user computer system turbine upgrade criteria;
identifying a turbine upgrade data set that corresponds to the received turbine upgrade criteria from a mapping of turbine upgrade data sets to turbine upgrade criteria; and
sending the identified turbine upgrade data set to the user computer system.

15. The method of claim 14 wherein the turbine upgrade criteria is a ranking of turbine upgrade criteria.

16. The method of claim 15 wherein the turbine upgrade criteria include a cost criterion, an installation time criterion, a power criterion, or an efficiency criterion.

17. The method of claim 14 wherein the turbine upgrade criteria is a turbine identification number.

18. The method of claim 14 wherein the turbine upgrade data set comprises a turbine performance chart illustrating turbine power output verses gas flow through the turbine.

19. A method for presenting data related to upgrading steam plant equipment, the method comprising:
receiving a request for data related to upgrading the steam plant equipment;
receiving selected information about the steam plant equipment;
providing a plurality of steam plant equipment upgrade criteria;
receiving a ranking of the upgrade criteria;
selecting an upgrade for the steam plant equipment based on the received selected information about the steam plant equipment and the received ranking of the upgrade criteria;
retrieving upgrade characteristics corresponding to the selected upgrade for the steam plant equipment; and
providing the retrieved upgrade characteristics.

20. The method of claim 19 wherein the steam plant equipment has an identification number and wherein selecting an upgrade for the steam plant equipment comprises:
identifying a best match upgrade that corresponds to the received ranking of the upgrade criteria from a best match table that maps upgrades to rankings of the upgrade criteria;
identifying a technically possible upgrade that corresponds to the steam plant equipment's identification number from a technically possible table that maps upgrades to identification numbers; and
selecting an upgrade for the steam plant equipment based on the identified best match upgrade and the identified technically possible upgrade.

21. The method of claim 19 wherein providing a plurality of steam plant equipment upgrade criteria comprises providing a cost criterion, a delivery lead-time criterion, a power criterion, or an efficiency criterion.

22. The method of claim 19 wherein retrieving upgrade characteristics corresponding to the selected upgrade comprises retrieving data that illustrates performance and economic aspects of the steam plant equipment both with the upgrade and without the upgrade.

23. The method of claim 19 wherein the steam plant equipment comprises a steam turbine and a boiler, and wherein retrieving upgrade characteristics corresponding to the selected upgrade comprises retrieving performance or economic data related to the upgrade of the steam turbine and the boiler.

24. The method of claim 19 wherein retrieving upgrade characteristics corresponding to the selected upgrade comprises retrieving performance or economic data related to the upgrade.

25. A computer-readable medium containing a display description for comparing upgraded steam plant equipment to non-upgraded steam plant equipment, the display description comprising a performance chart portion, the performance chart portion illustrating a power output of the non-upgraded steam plant equipment and a power output of the upgraded steam plant equipment.

26. The computer-readable medium of claim 25 wherein the performance chart portion illustrates power output verses steam flow.

27. The computer-readable medium of claim 25 wherein the performance chart portion illustrates a generator capacity.

28. The computer-readable medium of claim 25 wherein the performance chart portion illustrates a boiler NOx emissions limited operating region.

29. The computer-readable medium of claim 25 wherein the display description further comprises:
an economic data portion, the economic data portion containing a price field that is related to a price of the upgraded steam plant equipment, and an internal rate of return field that is related to an internal rate of return on an investment in the upgraded steam plant equipment.

30. The computer-readable medium of claim 25 wherein the performance chart portion illustrates an original turbine power output at an original steam flow, and wherein the performance chart portion illustrates an increase in power output that could be gained with a turbine upgrade at the original steam flow.

31. The computer-readable medium of claim 25 wherein the performance chart portion includes a green portion that indicates a region in which a steam turbine can operate without a boiler exceeding a prescribed NOx emission level.

32. The computer-readable medium of claim 25 wherein the performance chart portion includes a yellow portion that indicates a region in which a steam turbine can operate without a boiler exceeding a prescribed NOx emission level if an upgrade is made to the boiler.

33. The computer-readable medium of claim 25 wherein the display description includes an icon linked to a quote bin display description, the quote bin display description containing a price related to a steam plant equipment upgrade.

34. The computer-readable medium of claim 25 wherein the display description is a first display description further comprising:
an economic data portion, the economic data portion containing economic data related to a first upgrade; and
an update information icon, the update information icon being linked to a second display description containing economic data related to a second upgrade.

35. The computer-readable medium of claim 25 wherein the display description is a first display description comprising a performance chart portion that illustrates a power output of the upgraded steam plant equipment with a first upgrade, and wherein the first display description further comprises:
an upgrade option portion, the upgrade option portion containing a link to a second display description comprising a performance chart portion that illustrates a power output of the upgraded steam plant equipment with a second upgrade.

36. The computer-readable medium of claim 25 wherein the display description further comprises:
an economic data portion; and
a save icon for saving the performance chart portion or the economic data portion to a storage medium.

37. A computer-readable medium containing a display description related to a steam turbine and a boiler, the display description comprising a performance chart portion, the performance chart portion illustrating a power output of the steam turbine verses steam flow, the performance chart portion also illustrating a region in which the steam turbine can operate without the boiler exceeding a prescribed NOx emission level.

38. The computer-readable medium of claim 37 wherein the performance chart portion illustrates a generator capacity.

39. The computer-readable medium of claim 37 wherein the performance chart portion illustrates a region in which the steam turbine can operate without the boiler exceeding the prescribed NOx emission level after an upgrade has been made to the boiler.

40. The computer-readable medium of claim 37 wherein the display description further comprises:
an economic data portion, the economic data portion containing a price field that is related to a price of an upgrade to either the steam turbine or the boiler.

41. The computer-readable medium of claim 37 wherein the performance chart portion illustrates an original turbine power output at an original steam flow, and wherein the performance chart portion illustrates an increase in power output that could be gained with a turbine upgrade at the original steam flow.

42. The computer-readable medium of claim 37 wherein the performance chart portion comprises:
a green portion that indicates a region in which the steam turbine can operate without the boiler exceeding the prescribed NOx emission level if a first upgrade is made to the boiler;
a yellow portion that indicates a region in which the steam turbine can operate without the boiler exceeding the prescribed NOx emission level if a second upgrade is made to the boiler; and
a blue portion that indicates a region in which the steam turbine can operate without the boiler exceeding the prescribed NOx emission level if a third upgrade is made to the boiler.

43. The computer-readable medium of claim 37 wherein the display description includes an icon linked to a quote bin display description, the quote bin display description containing a price related to an upgrade of the boiler.

44. The computer-readable medium of claim 37 wherein the display description is a first display description further comprising:
an economic data portion, the economic data portion containing economic data related to a first boiler upgrade; and
an update information icon, the update information icon being linked to a second display description containing economic data related to a second boiler upgrade.

45. The computer-readable medium of claim 37 wherein the display description further comprises:
an economic data portion; and
a save icon for saving the performance chart portion or the economic data portion to a storage medium.

46. A computer system for presenting data related to upgrading steam plant equipment, the computer system comprising:
means for receiving a request related to upgrading the steam plant equipment;
means for providing an information display description configured to obtain selected information about the steam plant equipment;
means for receiving the selected information about the steam plant equipment;
means for selecting an upgrade for the steam plant equipment based on the received selected information about the steam plant equipment;
means for retrieving an upgrade display description from an analysis engine, the upgrade display description containing upgrade characteristics corresponding to the selected upgrade of the steam plant equipment; and
means for providing the upgrade display description.

47. The computer system of claim 46 further comprising:
means for providing an upgrade criteria display description containing a plurality of steam plant equipment upgrade criterion, the upgrade criteria display description being configured to receive a ranking of the upgrade criteria;
means for receiving the ranking of the upgrade criteria; and
means for selecting an upgrade for the steam plant equipment based on the received selected information about the steam plant equipment and the received ranking of the upgrade criteria.

48. The computer system of claim 46 wherein the steam plant equipment has an identification number, and wherein the means for selecting an upgrade for the steam plant equipment comprises:
means for identifying a best match upgrade that corresponds to the received ranking of the upgrade criteria from a best match table that maps upgrades to rankings of the upgrade criteria;
means for identifying a technically possible upgrade that corresponds to the steam plant equipment's identification number from a technically possible table that maps upgrades to identification numbers; and
means for selecting an upgrade for the steam plant equipment based on the identified best match upgrade and the identified technically possible upgrade.

49. A computer-readable medium whose contents cause a computer system to present data related to upgrading steam plant equipment, the data being presented by a method comprising:
receiving a request related to upgrading the steam plant equipment;
providing an information display description configured to receive selected information about the steam plant equipment;
receiving the selected information about the steam plant equipment;
selecting an upgrade for the steam plant equipment based on the received selected information about the steam plant equipment;
retrieving an upgrade display description from an analysis engine, the upgrade display description containing upgrade characteristics corresponding to the selected upgrade of the steam plant equipment; and
providing the upgrade display description.

50. The computer-readable medium of claim 49 wherein the method further comprises:
providing an upgrade criteria display description containing a plurality of steam plant equipment upgrade criterion, the upgrade criteria display description being configured to receive a ranking of the upgrade criteria;
receiving the ranking of the upgrade criteria; and
selecting an upgrade for the steam plant equipment based on the received selected information about the steam plant equipment and the received ranking of the upgrade criteria.

51. The computer-readable medium of claim 50 wherein providing an upgrade criteria display description comprises providing a display description containing a cost criterion field, an installation time criterion field, a power criterion field, or an efficiency criterion field.

52. A computer-readable medium whose contents cause a computer system to select one or more upgrades for steam plant equipment, the steam plant equipment having a selected identification number, the one or more upgrades being based on selected upgrade criteria, the one or more upgrades being selected by a method comprising:
identifying one or more best match upgrades that correspond to the received ranking of the upgrade criteria from a best match table that maps upgrades to rankings of the upgrade criteria;
identifying one or more technically possible upgrades that correspond to the steam plant equipment's identification number from a technically possible table that maps upgrades to identification numbers; and
selecting an upgrade for the steam plant equipment based on the identified best match upgrades and the identified technically possible upgrades.
